(19) United States
(12) Patent Application Publication
(10) Pub. No.: US 2014/0021752 A1
(43) Pub. Date: Jan. 23, 2014

(54) BICYCLE SEAT CONVERTER

(71) Applicant: Kent von Letkemann, Tigard, OR (US)

(72) Inventor: Kent von Letkemann, Tigard, OR (US)

(21) Appl. No.: 13/555,000

(22) Filed: Jul. 20, 2012

(51) Int. Cl. B60N 2/32

(52) U.S. Cl. 297/195.11

(57) ABSTRACT

A seating device using a bicycle seat post as one leg of a tripod seat base, employs a clamp member attaching to the seat post and receiving two other tripod leg portions therein. A web member extending from lower portions of the two other tripod leg portions passes in front of the lower seat post portion, creating tension for providing a seat base using the bicycle seat as the seating surface.

### BACKGROUND OF THE INVENTION

This disclosure relates to seating, and more particularly to a device for easily converting a bicycle seat to a freestanding seat.

When riding bicycles, it may be desirable to stop for a break, to rest or have refreshments, lunch, etc. It would be desirable to be able to have a chair or other seating arrangement for use during the rest break.

### SUMMARY OF THE INVENTION

In accordance with the disclosure, a device is provided to use the seat of a bicycle to create a freestanding seat that a bicycle rider can use off of the bike.

Accordingly, it is an advantage of the present disclosure to provide an improved seat for use in conjunction with a bicycle.

It is a further advantage of the present disclosure to provide an improved seat converter for making a freestanding seat temporarily using a bicycle's seat.

It is yet another advantage of the present disclosure to provide an improved method of providing a freestanding seat using a bicycle seat.

The subject matter of the present technology is particularly pointed out and distinctly claimed in the concluding portion of this specification. However, both the organization and method of operation, together with further advantages and embodiments thereof, may best be understood by reference to the following description taken in connection with accompanying drawings wherein like reference characters refer to like elements.

### BRIEF DESCRIPTION OF THE DRAWINGS

FIG. 1 is a side perspective view of the bicycle seat converter;

FIG. 2 is a front perspective view of the bicycle seat converter;

FIG. 3 is a top view of the bicycle seat converter;

FIG. 4 is an enlarged partial top view of the bicycle seat converter;

FIG. 5 is an enlarged partial bottom view of the bicycle seat converter;

FIG. 6 is an enlarged partial left side view of the bicycle seat converter;

FIG. 7 is an enlarged front view of the bicycle seat converter;

FIG. 8 is a view illustrating attachment of a leg to the member;

FIG. 9 is a bottom view of the clamp base member;

FIG. 10 is a sectional view taken along line 10-10 of FIG. 9;

FIG. 11 is a sectional view taken along line 11-11 of FIG. 9;

FIGS. 12 and 13 are perspective views of the clamp base member;

FIG. 14 is a front view of the clamp base member;

FIGS. 15 and 16 are further perspective views of the clamp base member;

FIG. 17 is a side view of the clamp base member

FIG. 18 is a rear view of the clamp base member;

FIG. 19 is a top view of the clamp base member;

FIG. 20 is a top view of the portion 26 of the clamp base;

FIGS. 21 and 22 are side views of the clamp base portion 28; and

FIG. 23 is a perspective view with seat attached showing an alternative embodiment.

### DETAILED DESCRIPTION

The system according to a preferred embodiment of the present invention comprises a device to convert a bicycle seat into a freestanding seat to be used off the bicycle.

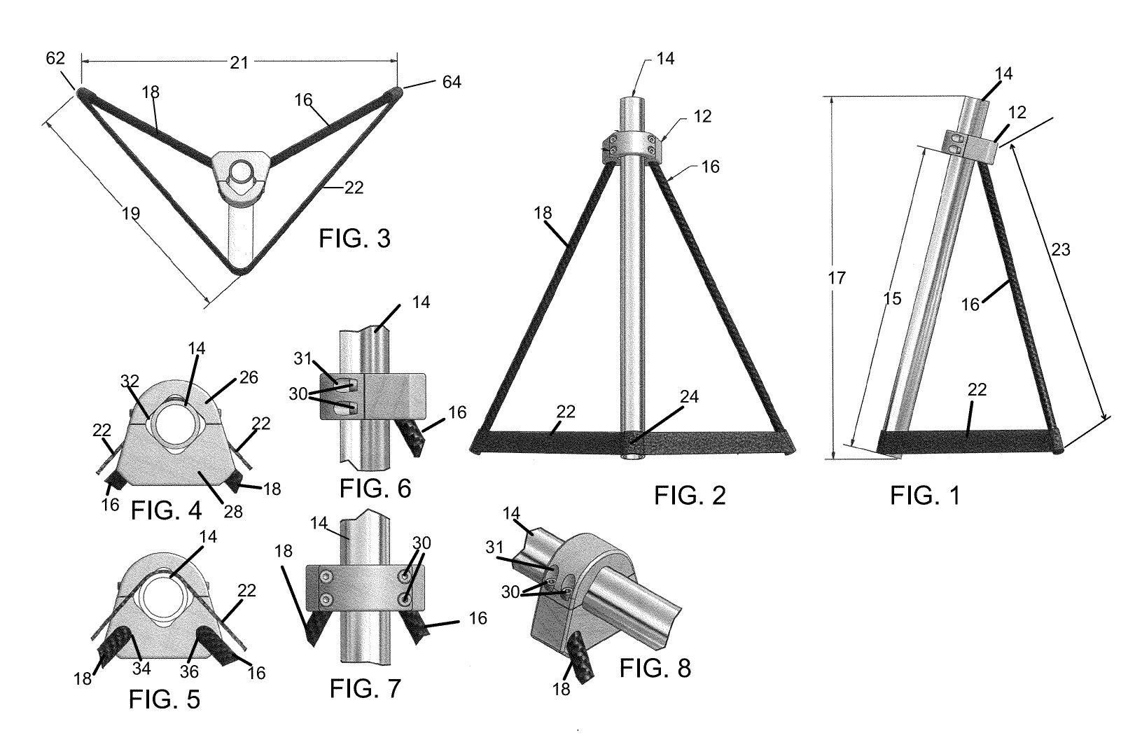

Referring to FIGS. 1 and 2, side and front perspective views of a bicycle seat converter 10, a clamp base 12 is designed to be removably attached to an upper portion of bicycle seat post 14 (illustrated without a seat being attached in FIGS. 1-3), and receives leg members 16, 18 therein in a manner to allow the legs to extend downwardly at a rearward angle. A web member extends between the legs, further having an optional post receiving portion 24 at approximately the center of the length thereof, for receiving a lower end of the bicycle post 14 therein, extending frontwardly from the legs around the front of seat post 14. The post receiving portion can comprise a sleeve which the post fits through, for example.

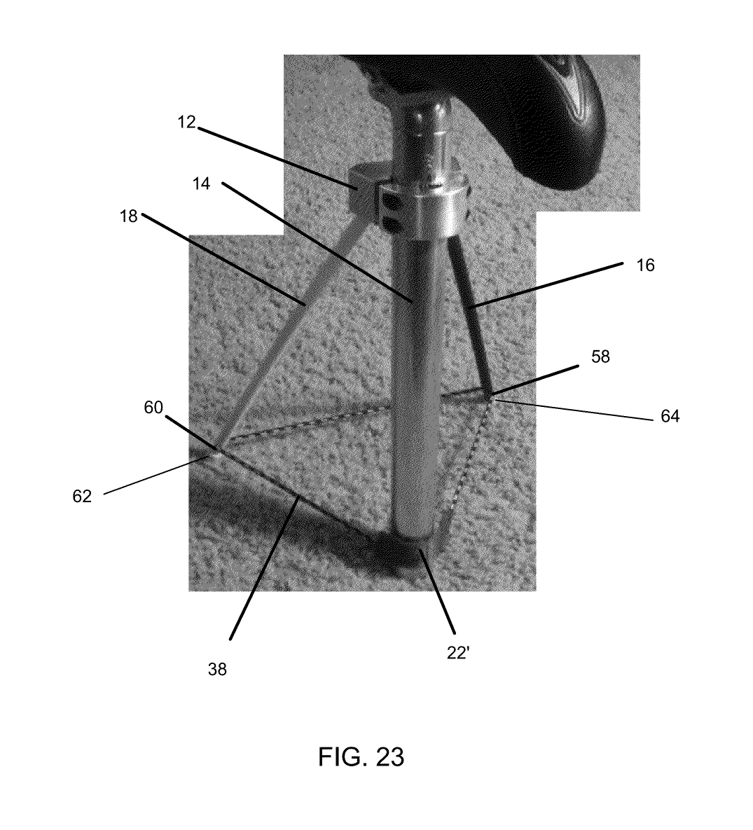

Accordingly, the combination of the clamp, legs, web members and seat post and the tension created from the positioning thereof provide a tripod-like configuration that produces, together with the bicycle seat, a suitable seating device, whereupon the user can sit on the bicycle seat (FIG. 23) as a freestanding seat.

Referring now to FIG. 4, an enlarged partial top view of the bicycle seat converter, it may be observed that the clamp base member 12 comprises a front portion 26 and rear portion 28 that are removably secured together by use of bolt members 30, wherein portion 26 includes bolt receiving holes 31 therein and portion 28 includes corresponding threaded bolt receiving portions 20. Loosening of the bolts 30 allows the bicycle seat post to be inserted into opening 32 defined in a center portion of the base member 12, whereupon tightening of the bolts will clamp to base member to the seat post.

Considering FIG. 5, an enlarged partial bottom view of the bicycle seat converter, the base member 12 includes leg receiving openings 34, 36 formed therein, extending partially into the body of the base 12, with an angled entry relative to the entry fact of the base. The holes 34, 36 are suitably circular in cross section in the illustrated embodiment, as are the leg members 16, 18, but this is not a requirement and the holes and legs may be other cross sectional shapes, such as triangular, square, oblong, or other desired shape.

FIGS. 6, 7 and 8, enlarged partial left side, front side and angled perspective views of the bicycle seat converter clamp base member portion with inserted bicycle seat post and leg members, further illustrate the operation.

Typical dimensions in a particular embodiment are, mount location of clamp base member to seat post bottom 15, 13.4 inches (34 cm), vertical extent of seat post when in use 17, 15.8 inches (40.1 cm), rear of leg 16 (or 18) to front edge of seat post 19, 8.4 inches (21.3 cm), spread of legs at rear 21, 10.5 inches (26.7 cm), individual leg length 23 is suitably 12 inches (30.5 cm) in a particular embodiment.

Typical construction material for the base clamp member 12 is aluminum, plastic, wood or other suitable material, while the legs 16, 18 are fiberglass. Web member 22 is nylon (or in an alternative embodiment (FIG. 23) a rope).

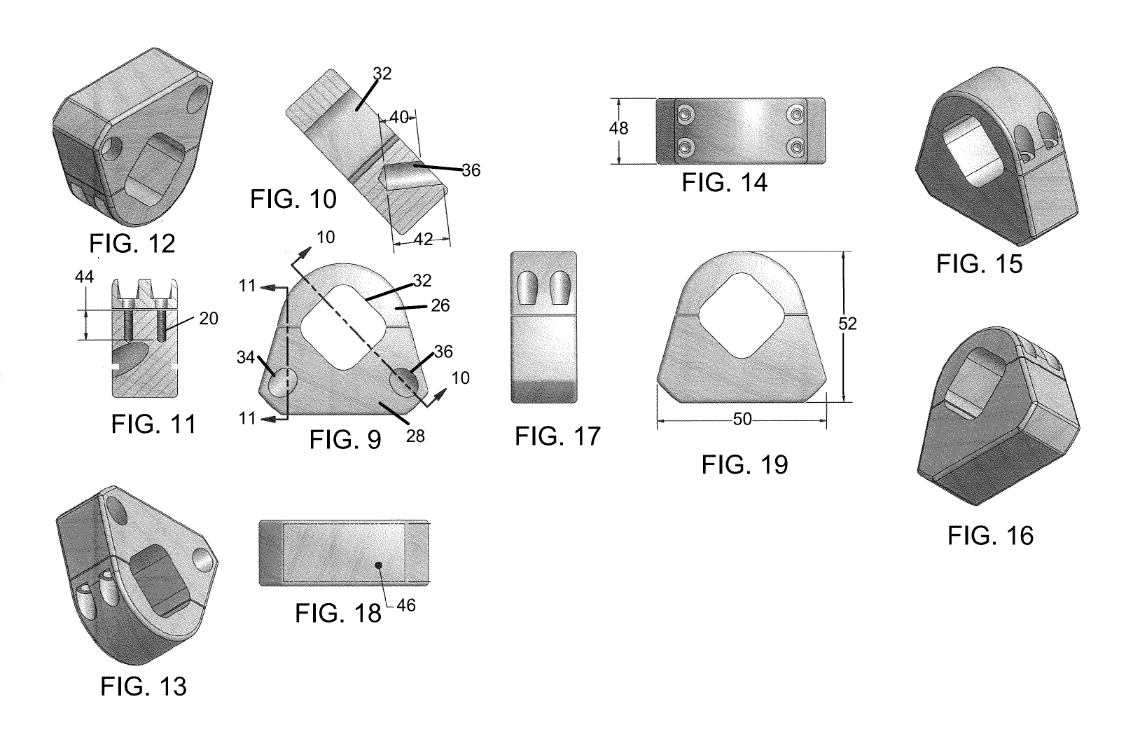

Referring to FIGS. 9-21, further details of the clamp base member 12 are illustrated. FIG. 9 is a bottom view with the front and rear portions 26, 28 in close engagement. Opening 32 is square in cross section, with rounded corners. Considering FIG. 10, a sectional view along line 10-10 of FIG. 9, the overall depth of the leg receiving opening 36 (and correspondingly, opening 34) is 0.6 inches (1.5 cm) at the shorter side 40 and 0.9 inches (2.3 cm) at the longer side 42. Referring to FIG. 11, a sectional view taken along line 11-11 of FIG. 9, the thread depth 44 of the fastener receiving holes 20 is suitably 0.45 inches (1.14 cm).

FIGS. 12, 13, 15 and 16 provide different perspective views of the clamp block member 12, when both portions are in close engagement. FIGS. 14, 17 and 18 provide front, side and rear views of the clamp block member. In FIG. 18, area 46 is available for branding or decorative use, providing a 1.8 by 0.9 inch (4.6 by 2.3 cm) area that can carry text and/or graphics. The thickness 48 of the clamp member is suitably 1.0 inches (2.5 cm), while the maximum width 50 (FIG. 19) is 2.6 inches (6.6 cm) and the height when the 2 portions 26/28 are closely engaged is 2.3 inches (5.8 cm), although this distance will change in use depending on the diameter of the seat post to which the clamp base member is attached.

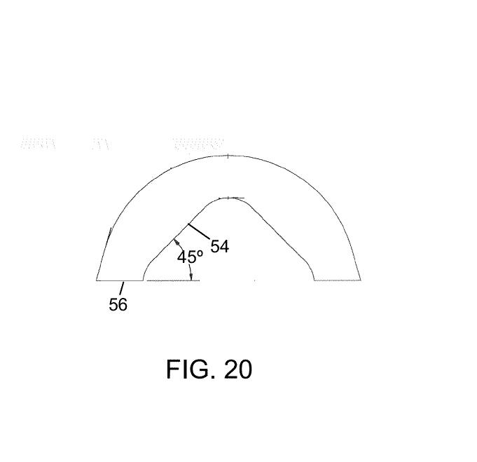

FIG. 20 is a top view of portion 26 of the base block member 12, wherein the sidewalls 54 thereof are formed at an angle of 45 degrees to the front face 56.

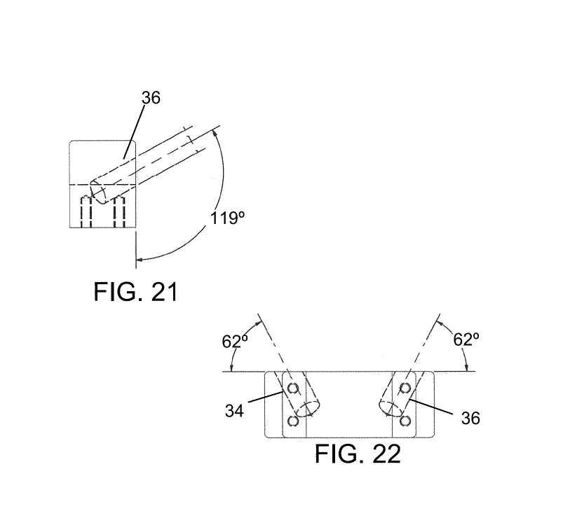

FIGS. 21 and 22 illustrate the angle of the leg receiving holes 34, 36, wherein the holes are formed at an angle of 119 degrees relative to the downward face of the clamp base 12 and 62 degrees relative to the edge face of the clamp base.

FIG. 23 is a perspective view with seat attached showing an alternative embodiment, wherein instead of the wider configuration web support strap 22 of FIGS. 1-8, a narrower rope-like member 38 is provided in a loop configuration, the member 38 passing through holes 58, 60 formed in the lower portions of legs 16, 18. Suitably climbing grade rope is employed, being flexible and strong, yet providing the desired tension. A short web portion 22′ is provided to interact with the bottom region of post 14, whereby when the web portion is put around the post it creates tension to secure the configuration for seating use. Feet members 62, 64 may be placed on the bottoms of legs 16, 18 to provide protection and friction for engagement with floors or other surfaces on which the seat is used, and suitably comprise a rubber or synthetic material. A corresponding protective foot member (not shown) is available to place over the bottom of the seat post for protection of the surface. In place of feet members 62, 64, collapsible expanding feet may be employed, to provide a wider contact base with the ground.

In summary, in accordance with the disclosure herein, a bicycle seat post can be removed, stand by itself and be used as a seat. The post will fit standard size seats. Alternatively, in place of using the provided post, the device will allow a person to remove the seat and post from the bicycle and use them as a seat on the ground or other surface.

Further options for use of the device include storing the legs 16, 18 and web 22, 22′ inside the seat post 14 when not in use. To assemble, the stored legs will be removed from the post and attached.

Also, a pointed end may be provided at the lower end of the post as an attachment thereto, which would stab into the ground for use outdoors.

In use, the seat is removed from the bicycle leaving the seat post attached to the seat. The user installs the clamp member 12 to the bike seat post 14 (the clamp member can remain affixed to the seat post indefinitely). The legs 16, 18 are inserted into the clamp base 12, with the web member 22 passed in front of the lower end of the seat post. The bike seat may now be used as a free standing seat.

The illustrated embodiment employs a clamp base member 12 that is secured by use of bolts and corresponding threads, but other methods of fastening can be employed. For example, in an alternative embodiment, a quick release clamp device is employed instead, allowing for quick placement and removal of the clamp portion when desired.

A further embodiment, in place of clamp base member, provides the leg receiving openings 34, 36 in the base of the seat or at the head of the bike seat post, formed at corresponding angles, rearwardly facing, removing the need for clamp base member 12.

Yet another embodiment employs a rear carrier rack mountable to the bike as the receiving base for attachment of the legs 16, 18, thereto. The rack mounts to the seat post and extends rearwardly (to provide support for carrying items on the bike). Corresponding holes 34, 36 are formed in the bottom of the carrier rack to receive the legs 16, 18 therein.

Accordingly, a portable three legged, tripod type seat utilizing the end user's existing bike seat and seat post is provided. Alternatively, a seat post 14′ may be provided separately from the bike rider's seat post, with the bike seat simply attached to the post 14′. A two piece component 12 clamps onto the seat post at a point near the top end of the seat post, beneath the seat, with the component 12 accepting 2 opposing legs that in conjunction with the seat post create a tripod. The legs will be joined together by a pliable component (web 22) affixed to one end of each leg. The angle and length of the legs will vary depending on seat post height and angle. When deployed, this pliable component will wrap around the end of the seat post creating strength through triangulation and tension. The legs are composed of a rigid yet flexible material which, when properly installed with the strap positioned around the seat post, will place the legs into tension.

While plural embodiments of the technology have been shown and described, it will be apparent to those skilled in the art that many changes and modifications may be made without departing from the broader aspects. The appended claims are therefore intended to cover all such changes and modifications as fall within the true spirit and scope of the technology.

1. A seating member for employing a bicycle seat post to create a free-standing seat, comprising:
a base member for attaching to an upper portion of the bicycle seat post;
a leg portion,
wherein the base member has a receiving portion for receiving the leg portion therein, and in combination with the seat post, providing a seat base, and in further combination with a bicycle seat that attaches to the seat post, providing the free-standing seat.

2. The seating member according to claim 1, wherein said leg portion comprises first and second extension members which extend from the base member to the ground.

3. The seating member according to claim 2, further comprising a web member extending from a lower portion of the extension members to a lower portion of the seat post.

4. The seating member according to claim 2, wherein said base member comprises a clamp attachable to the seat post and further comprises a receiving portion for receiving the leg portion therein.

5. The seating member according to claim 4, wherein said receiving portions comprises 2 angled holes formed in the clamp and said leg portion comprises 2 leg members adapted to be inserted into said angled holes.

6. The seating member according to claim 5, wherein said leg members comprise elongated members.

7. The seating member according to claim 6, wherein said leg members comprise composite poles.

8. A seat employing a bicycle seat and seat post, comprising:
a clamp member for attaching to an upper portion of the seat post, said clamp member having 2 leg receiving portions defined therein;
first and second leg portions adapted to be received by the leg receiving portions; and
a tension member providing tension between the seat post and said first and second leg portions, to define the seat.

9. The seat according to claim 8, wherein said leg portions comprises elongate poles.

10. The seat according to claim 8, wherein said tension member comprising a web member extending from a lower portion of the first and second leg portions to a lower portion of the seat post.

11. The seat according to claim 8, wherein said clamp member leg receiving portions comprises orifices defined therein for receiving the first and second leg portions therein.

12. The seat according to claim 11, wherein said orifices comprises 2 angled holes formed in the clamp member.

13. A seating member for employing a bicycle seat post to create a free-standing seat, comprising:
first and second leg receiving portions formed near the bicycle seat;
first and second leg portions adapted to be received in the first and second leg receiving portions; and
a tensioning member for maintaining tension between said first and second leg members and said bicycle seat, providing the free-standing seat.

14. The seating member according to claim 13, wherein said first and second leg receiving portions are formed in a seat post of said bicycle seat.

15. The seating member according to claim 14, wherein said tensioning member comprises a web member extending from a lower portion of the leg portions to a lower portion of the seat post.

16. The seating member according to claim 13, wherein said first and second leg receiving portions are formed in said bicycle seat.

17. The seating member according to claim 16, wherein said tensioning member comprises a web member extending from a lower portion of the leg portions to a lower portion of a seat post of the bicycle seat.

18. The seating member according to claim 13, wherein said leg members comprise elongated members.

19. The seating member according to claim 13, wherein said leg members comprise composite poles.
